(19) United States
(12) Patent Application Publication
(10) Pub. No.: US 2006/0253223 A1
(43) Pub. Date: Nov. 9, 2006

(54) Robotic trajectories using behavior superposition

(75) Inventors: Robert Edward Bodenheimer JR., Nashville, TN (US); Richard Alan Peters II, Nashville, TN (US)

Correspondence Address: MORGAN LEWIS & BOCKIUS LLP, 1111 PENNSYLVANIA AVENUE NW, WASHINGTON, DC, 20004, US

(73) Assignee: Vanderbilt University, Nashville, TN (US)

(21) Appl. No.: 11/331,629

(22) Filed: Jan. 13, 2006

Related U.S. Application Data
(63) Continuation-in-part of application No. 11/025,768, filed on Dec. 30, 2004.
(60) Provisional application No. 60/533,863, filed on Dec. 30, 2003.

(51) Int. Cl. G06F 19/00

(52) U.S. Cl. 700/245

(57) ABSTRACT

A system and method for robotic trajectory planning are described. The robotic trajectory is comprised of a least-mean-square (LMS) approximation of previously learned behaviors and a radial basis function (RBF) correction to the LMS approximation. The RBF correction ensures that the trajectory follows a learned behavior when the trajectory target corresponds to the target of the learned behavior.

### CROSS-REFERENCE TO RELATED APPLICATIONS

This application is a continuation-in-part of U.S. application Ser. No. 11/025,768, filed Dec. 30, 2004, which claims the benefit of prior filed provisional application Ser. No. 60/533,863, filed Dec. 30, 2003, which are both incorporated herein by reference in their entirety.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of the programs awarded through DARPA/NASA-JSC grants #NGT952, #NAG9-1428, #NAG9-1446, and #NAG9-1515.

### BACKGROUND OF THE INVENTION

1. Field of the Invention

The present invention relates to the field of intelligent autonomous robot architectures. More specifically, the invention relates to determining a trajectory through a state space of the robot using superposition of previously learned behaviors.

2. Description of the Related Art

Human motion appears effortless but is difficult to implement in a robot. For example, a human baby can usually reach and grab a randomly placed object by the age of nine months and can do so with little apparent difficulty and with ordinary help from its parents. Training a robot to do the same requires more effort.

The reach-and-grab behavior is an example of a general problem of planning robotic motion. Robotic motion may be described by a trajectory in the robot's state space. Unfortunately, the high dimensionality of the robot's state space limits real-time ab initio calculations of the trajectory to only the most trivial and simplest behaviors. For example, a 7 degree-of-freedom (DoF) arm mated to a 12 DoF hand along with the appropriate sensors can produce a state vector having a dimensionality of over 100.

One method of training a robot is by teleoperation as described in U.S. Pat. No. 6,697,707 issued Feb. 24, 2004 to Peters, which is incorporated herein by reference in its entirety. Peters describes a training method wherein a human teleoperates a robot through a specific task while the robot records its state throughout the task. The task is repeated several times. The repeated tasks produce similar trajectories in the robot's state space and can be normalized and averaged to create an exemplar trajectory or behavior. Behaviors may be sequentially linked with other behaviors to accomplish different tasks.

The averaging of the repeated task trajectories to form an exemplar trajectory appears to work because the operator executes the same motion during each repeated task such that the deviations between each repeated task is small. Furthermore, in a reach-and-grab task, the end point location and orientation of the hand in each repeated task is the same. If a different end point location and orientation is desired, a new training session is usually required to create an exemplar trajectory with the new end point location and orientation. Training a robot for every possible end point location and orientation is prohibitively time consuming and expensive. Therefore, there remains a need for systems and methods for creating new trajectories from combinations of previously created, or learned, behaviors.

### SUMMARY OF THE INVENTION

A system and method for robotic trajectory planning are described. The robotic trajectory is comprised of a least-mean-square (LMS) approximation of previously learned behaviors and a radial basis function (RBF) correction to the LMS approximation. The RBF correction ensures that the trajectory follows a learned behavior when the trajectory target corresponds to the target of the learned behavior.

One embodiment of the present invention is directed to a method for determining a trajectory for a robot, the method comprising: providing at least one behavior, each of the at least one behavior having an associated target; approximating the trajectory based on the at least one behavior and the associated target; and correcting the trajectory based on a new target associated with the trajectory.

### BRIEF DESCRIPTION OF THE DRAWINGS

The invention will be described by reference to the preferred and alternative embodiments thereof in conjunction with the drawings in which:

FIG. 1 is a plot showing the arm and joint positions as a function of time during a reach-and-grab task trial;

FIG. 2 is a plot of the sum of the instantaneous MSV as a function of time during a reach-and-grab task trial; and

FIG. 3 is a flow diagram illustrating an embodiment of the present invention.

### DETAILED DESCRIPTION

Some embodiments of the present invention may be implemented on a robotic platform such as that described in Ambrose, R. O., H. Aldridge, R. S. Askew, R. R. Burridge, W. Bluethmann, M. Diftler, C. Lovchik, D. Magruder, F. Rehnmark, “Robonaut: NASA's space humanoid”, IEEE Intelligent Systems, IEEE Intelligent Systems, vol. 15, no. 4, pp. 57-63, July-August, 2000, which is incorporated herein by reference in its entirety. It should be understood, however, that methods and systems described herein are not limited to a specific robotic platform and may be implemented on other robotic platforms, which are intended to be within the scope of the present invention.

Robonaut was developed by the Dexterous Robotics Laboratory (DRL) of the Automation, Robotics, and Simulation Division of the NASA Engineering Directorate at Lyndon B. Johnson Space Center in Houston, Tex. In size, the robot is comparable to an astronaut in an EVA (Extra-Vehicular Activity) suit. Each seven degree of freedom (DoF) Robonaut arm is approximately the size of a human arm, with similar strength and reach but with a greater range of motion. Each arm mates with a dexterous end-effector, a 12-DoF hand, to produce a 19-DoF upper extremity. The robot has manual dexterity sufficient to perform a wide variety of tasks requiring the intricate manipulation of tools and other objects.

Robonaut is physically capable of autonomous operation but may be controlled directly by a person via teleoperation. In teleoperation mode, every motion made by Robonaut reflects a similar motion made by the operator, who perceives the robot's workspace through full-immersion virtual reality. The operator wears a helmet that enables her or him to see through the robot's stereo camera head and hear through the robot's binaural microphones. Sensors in gloves worn by the operator determine Robonaut's finger positions. Six-axis Polhemus sensors on the helmet and gloves determine the robot's arm and head positions. The operator guides the robot using only vision. The robot's haptic sensors do not transmit touch sensations to the operator nor do the force sensors project forces onto the operator's gloves.

Each 7-DoF arm is commanded independently by specifying the 6D Cartesian pose (position and orientation) of its hand's point-of-reference (PoR). The PoR is located on the back of the hand so that it corresponds to the location of Polhemus sensor on the corresponding teleoperator glove. Usually the seventh DoF is computed by an inverse kinematics (IK) algorithm that minimizes joint velocities. The operator can, by specifying an angle, command the elbow orbit position if the IK algorithm computes one that is problematic for the desired motion in the current environment. The elbow position is specified by the angle between the plane formed by the shoulder, elbow, and wrist and the vertical plane of right-left symmetry of the robot.

Robonaut's arm-hand systems have a high bandwidth dynamic response (the servo control loop operates at 50 Hz) that enables it to move quickly, if necessary, under autonomous operation. During teleoperation, however, the response of the robot is slowed to make it less susceptible to jitter in the arms of the teleoperator and to make it safe for operation around people, unprotected either on the ground or in pressurized EVA suits in space. The slowdown is, effectively, to a 10 Hz loop with the teleoperator. The purposeful limitation of maximum joint velocity affects not only the motion analysis described below but also the superposition of learned behaviors, especially with respect to the time-warping of component behaviors described below.

Robonaut has many sensors, including a color, stereo camera platform embedded in a head mounted on a 3-DoF neck, and binaural microphones located on opposite sides of the head, parallel to the stereo camera baseline. The two hand/wrist modules contain 84 sensors for feedback and control, 60 of which are analog and require signal conditioning and digitization. Each DoF has a motor position sensor, a joint force sensor, and a joint absolute position sensor. The two arm modules contain 90 sensors, 80 of which are analog. Each actuator contains a motor incremental position sensor, redundant joint torque sensors, redundant joint absolute position sensors, and four temperature sensors distributed throughout the joint. Each arm employs relative optical encoders in five of its joints. The encoders reside on the motor side of the gear train and have resolutions ranging between 200 and 1000 counts per degree of arm motion. The two wrist joints employ resolvers integrated into the motor assemblies.

The Robonaut stereo vision system uses object shape to determine the six-axis pose of well-defined objects, such as wrenches and tables, as well as variable-form structures, such a human limbs. The robot's field-of-view (FoV) is preprocessed using patch correlation on Laplacian-of-Gaussian (LoG) filtered image pairs to generate 3D range maps as well as binary, 2D range maps taken over a series of range intervals. Initially, four DoFs of a known object are estimated roughly through an efficient matching of large sets of 2D silhouette templates against the 2D range maps. This estimate is refined to give a more precise pose estimate in all six DoFs. The strongest silhouette matches are used to seed a process, which matches 3D sets of contour templates against 3D range maps. Although considerably more expensive computationally than 2D, a 3D process is necessary for the robot to handle and manipulate objects. A high level of precision is obtained in real time because most of the environment is filtered out by the much faster 2D silhouette matching process.

After low-pass filtering the outputs with a time constant of about 0.2 seconds (FIR averaging), the vision system is accurate to within 0.003 meters and 2.0 degrees in the workspace of the robot. This is as measured relative to an object with a calibrated pose. The general accuracy of the system in deployment is within about 0.015 meters and 5 degrees. Currently, most estimation error is caused by the correlation mismatches on surfaces that are metallic (reflective) or low in texture (e.g., a black plastic drill handle). The system outputs the poses of recognized objects within its FoV at a rate of about 7 Hz. The overall latency through the system (photons hitting lens to vision system Ethernet output) is about 0.22 seconds. Latency from vision output to robot actuation is approximately 0.38 seconds.

Although the teleoperator may be unaware of most of it, all sensory data is available in real time for the robot's computers to analyze. The sensory data recorded during teleoperation may be processed by the robot to create, or learn, behaviors performed via teleoperation. The learned behaviors may be used by Robonaut in autonomous operations. Table 1 lists the data signals recorded during teleoperation. The signals are recorded at a nominal rate of 50 Hz but some signals, such as those produced by vision, are recorded at slower rates.

TABLE 1
Signals Recorded From Robonaut.

| Signal | Dimension |
|---|---|
| End-effector position, actual | 3 |
| End effector rotation mat, actual | 9 |
| Arm orbit angle, actual | 1 |
| End-effector position, requested | 3 |
| End effector rotation mat, requested | 9 |
| Arm orbit angle, requested | 3 |
| Arm 3-axis force on wrist | 3 |
| Arm 3-axis torque on wrist | 3 |
| Arm 3-axis force on shoulder | 3 |
| Arm 3-axis torque on shoulder | 3 |
| Arm joint positions | 7 |
| Arm joint torques | 7 |
| Hand force on fingers | 5 |
| Hand joint positions | 12 |
| Hand joint torques | 12 |
| Hand tactile sensors | 19 |
| Visual object name | 1 |
| Visual object pose | 6 |
| Teleoperator voice command | 1 |

Teaching a robot a task includes a training phase where the robot is repeatedly teleoperated through the task by a remote operator. During teleoperation, the robot's sensor data is recorded as a vector time series for later analysis by the robot. After the robot has completed the training phase, a learning phase is initiated in the robot where the robot segments the time series into episodes, normalizes each episode with the corresponding episode from the other repeated tasks, and creates an exemplar episode, or behavior, from the average of the normalized episodes.

For purposes of illustration, teaching a robot to perform a reach-and-grab task is now described although it is understood that the present invention is not limited to this particular task. An operator teleoperates the robot to reach forward to a wrench affixed to a frame, grasp the wrench, hold it briefly, release it, and withdraw the arm. The task is repeated at least once to produce at least two vector time series, herein referred to as trials, for the task. In a preferred embodiment, the task is repeated four times to produce five trials for the task.

Each vector time series is partitioned into SMC episodes. For the reach and grab task, each trial is partitioned into five SMC episodes corresponding to reach, grasp, hold, release, and withdraw. Each SMC episode is demarcated by an SMC event. The SMC event is determined based on a sum, z, of the mean-squared velocity (MSV) of the joint angles of the robot's joints as described in Fod, A., M. J. Matari\ddot{c}, and O. C. Jenkins, “Automated Derivation of Primitives for Movement Classification”, Autonomous Robots, vol. 12 no. 1, pp. 39-54, January 2002, incorporated herein by reference. In a preferred embodiment, an SMC event defines the beginning or end of a significant acceleration or deceleration in the arm-hand system. The beginning of a MSV peak occurs at time, t0, if z(t0) is greater than or equal to a threshold value, c1, and z(t0−1) is less than c2, and at some time, t1>t0, z(t1) is greater than a second threshold value, c2. Similarly, the end of a MSV peak occurs at time, t2, if z(t2) is less than or equal to c1 and z(t2−1) is greater than c1 and at some time, t1 less than t2, z(t1) is greater than c2. The threshold values, c1 and c2, may be empirically determined from the instantaneous MSV. In a preferred embodiment, the value of c2 may be selected to partition the time series into the expected number of episodes, which in the example is five. The first threshold value, c1, may be selected as the fifth percentile of a sampled distribution of measured accelerations.

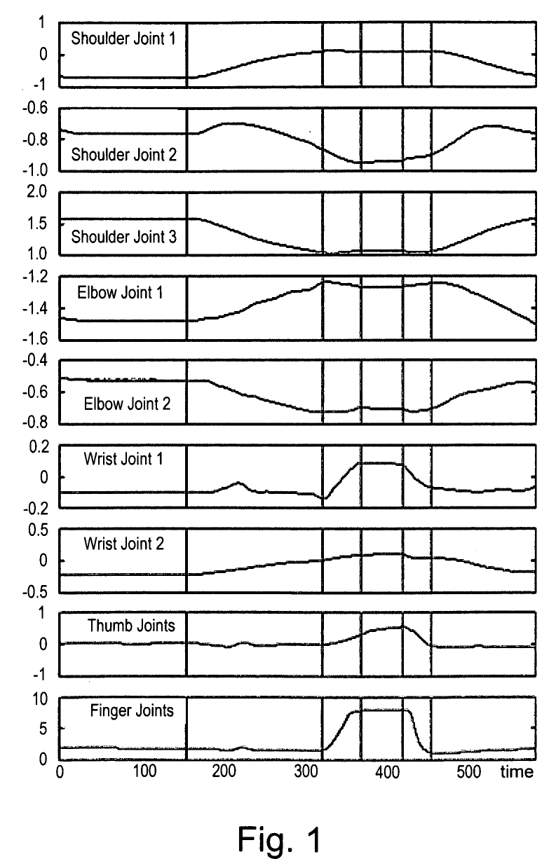

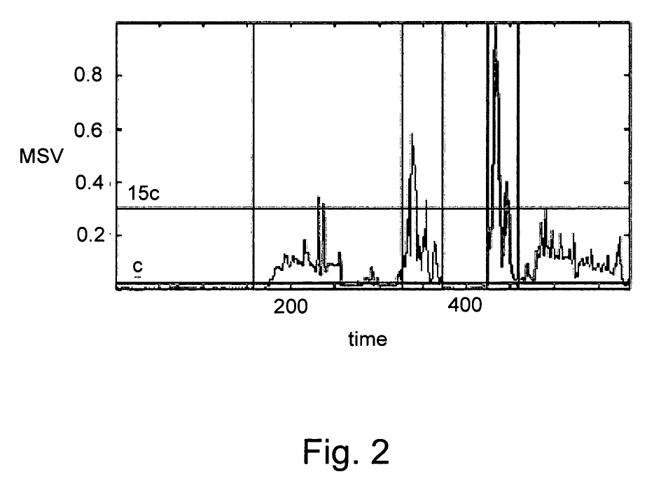

FIG. 1 is a plot showing the arm and joint positions as a function of time during a reach-and-grab task trial. In FIG. 1, the vertical lines indicate SMC events that partition the trial into five episodes corresponding to reach, grab, hold, release, and withdraw. Each episode is bounded by an SMC event. FIG. 2 is a plot of the sum of the instantaneous MSV as a function of time during a reach-and-grab task trial. In FIG. 2, the vertical lines indicate SMC events. Also shown in FIG. 2, are two horizontal lines indicating the first (c) and second (15c) threshold values used to determine SMC events.

Each SMC episode is time-warped by resampling the episode time series such that the duration of the resampled time series is equal to the average duration of the corresponding trial episodes. For example, the average duration of all the trials may be 150 samples in duration. Each trial is resampled such that the resampled trials each have a duration of 150.

An exemplar episode, herein referred to as a behavior, is created by point-wise linear averaging the five time-warped episodes. It is believed that averaging the time-warped episodes enhances those characteristics of the sensory and motor signals that are similar in the trials while diminishing those that are not. Another method for creating the behavior may use a median value of the episode trials when, for example, a signal exhibits nonlinear behavior with respect to time, such as, for example, when a motor is turned on or off.

Once the robot has created a behavior for each episode in the task, the behaviors are stored in the memory of the robot and can be retrieved and sequentially executed autonomously to perform the same task. If, however, the wrench is placed in a different location, the robot will fail to grasp the wrench in the new location because the robot has only learned to grasp the wrench at the original location. In some embodiments, the trajectory of the robot is adjusted toward the new grasp location while the robot is executing the learned behaviors and is herein referred to as the Auto Grasp method. While satisfactory placement accuracy of the hand may be obtained when the new location is close to the original location, the inventor has discovered that task success decreases quickly as the distance between the original and new locations increases. Alternatively, the robot may be trained to grasp at all possible locations. This alternative, however, is impractical due to the excessive training time and the unlikelihood of enumerating all possible grasp locations.

In some embodiments, the robot is trained to reach-and-grasp at several different locations and the learned behaviors are interpolated to determine a trajectory to a new location, referred herein as the Linear Grasp method. For example, a robot may be trained to reach-and-grab a wrench located at eight different locations that define a polyhedral volume. The robot may create a new trajectory to a location within the polyhedral volume by linearly interpolating the eight learned behaviors according to the end locations of the eight learned behaviors. Experiments conducted on Robonaut indicate that the Linear Grasp method exhibits a higher success rate at the reach-and-grab task than the Auto Grasp method.

In a preferred embodiment, a robotic trajectory is created using an interpolation method referred to as Verbs and adverbs (VaV). The VaV method as applied to computer graphics animation is described Rose, C., M. Cohen, and B. Bodenheimer, “Verbs and Adverbs: Multidimensional Motion Interpolation”, IEEE Computer Graphics and Applications, vol. 18, no. 5, pp. 32-40, September 1998, incorporated herein by reference.

In the context of planning or creating robotic trajectories, a verb is a state-space trajectory of a behavior and is designated by mᵢ(t) where the subscript i represents the i-th behavior and ranges from 1 to Ne, where Ne is the number of behaviors. The state-space trajectory has a dimension of Ns+1 where Ns is the dimension of the robot's sensory-motor state-space and the 1 accounts for the time dimension. Similarly, an adverb is the 3D location of the target object and is designated by a Na-dimensional vector, p. In the context of robotic trajectories, the adverb of a trajectory is referred to herein as a target. The targets corresponding to the Ne behaviors are indicated by pᵢ, where the subscript i represents the target location of i-th behavior and ranges from 1 to Ne. Since a target represents a physical location, the target is not limited to parameterizing a single verb but may be used to parameterize more than one verb. For example, a reach-and-grab operation may include the verbs reach, grasp, hold, release, and withdraw. Each of the verbs may be parameterized by the same target corresponding to the target location of the operation.

The VaV interpolation method may be viewed as projecting the motion exemplars at each time, t, onto a Na+1-dimensional linear subspace of the sensory-motor state-space. The subspace is the range of a matrix, A(t), that is the least-mean-square (LMS) approximation of a mapping function, Φ, that maps pᵢ to mᵢ. The projection through A(t) is likely to be inaccurate that may be due, in part, to the nonlinearity of Φ and that Na<<Ns. The inventor has discovered that the inaccuracy of A(t) is such that the exemplar targets usually are not mapped to their corresponding verbs (exemplar motion trajectories) by A(t) alone.

A radial basis function (RBF) interpolation operator is defined that restores the exemplar's motion trajectory components lost in the projection such that the exemplar motion trajectories are recovered from a combination of the LMS approximation and the RBF operation on the exemplar adverbs. Once the RBF and A(t) are determined based on the Ne exemplar motion trajectory—target pairs, a new motion trajectory, m(t), based on a new target, p, may be computed using
m(t)=A(t)p^{h}+Q^{T}(t)r(p). (1)
In equation 1, m(t) is the motion trajectory through the robot's sensory-motor state-space and p^{h} is a homogeneous representation of the target, p, and is given by
p^{h}=[1p^{T}]^{T}. (2)

In equation 1, A(t) represents the LMS solution for the Ne exemplar trajectories, r(p) represents the RBF vector operating on the adverb, p, and may be viewed as a correction term to the LMS solution. The matrix, Q^{T}(t), represents weights applied to each RBF correction term. As used herein, a superscript T indicates a transpose of a matrix and a superscript −1 indicates an inverse of a matrix.

The LMS solution, A(t), is the solution that minimizes the mean squared error over all Ne verbs, i.e.,
min∥M(t)−A(t)P^{h}∥². (3)

In equation 3, M(t) is an Ns×Ne matrix of exemplar states at time t where the i-th column of M(t) is mᵢ(t), which is the vector of Ns state values of the i-th exemplar at time t. P^{h} is an (Na+1)×Ne matrix where the i-th column of P^{h} is p^{h}i, which is the homogeneous representation of the i-th exemplar target vector. A(t) is an Ns×(Na+1) matrix and is
A(t)=M(t)(P^{h})^{T}[P^{h}(P^{h})^{T}]⁻¹. (4)

The inventor has discovered that a trajectory, m(t), created using only the LMS solution (the first term on the right hand side of equation 1) does not, in many situations, move the robot hand to the target location. The second term on the right hand side of equation 1 adds a correction to the LMS solution such that the exemplar targets map to their respective verb.

In a preferred embodiment, a Gaussian function is selected as the radial basis function such that:
rᵢ(p)=e^{-β}^{ᵢ}^{ρ}^{ᵢ}^{²}^{(p)} (5)
where ρᵢ is the distance from p to pᵢ and βᵢ is a scaling parameter that may be adjusted to control the effect of the exemplar targets on the LMS correction term. In a preferred embodiment, each βᵢ is selected such that the closest exemplar adverb, pⱼ, to exemplar target, pᵢ, gives rᵢ(pⱼ)=0.01. The βᵢ are therefore given by

$${β}_{i} ( p ) = \frac{2 ln 10}{{min}_{j \neq i} \{ {‖ {p}_{j} - {p}_{i} ‖}^{2} \}} . \qquad ( 6 )$$

The matrix, Q(t), is an Ne×Ns matrix and is given by
Q^{T}(t)=\overline{M}(t)R⁻¹. (7)
In equation 7, R is a Ne×Ne matrix of RBF intensities at the locations of the Ne target vectors. The components of R, rᵢₖ, are equal to rᵢ(pⱼ) where the indices i and j range from 1 to Ne. The i-th row of R contains the values of the i-th RBF at each target location. The k-th column contains the values of all the RBFs at the location of target k. R is not a function of time because it depends on the exemplar targets, which are constant. If R is not invertible, a pseudo-inverse of R may be used in equation 7. In equation 7, \overline{M}(t) is an Ns×Ne matrix of residuals comprising the difference between the exemplar motion trajectory and the LMS trajectory

The LMS solution, A(t), and the RBF weights, Q^{T}(t), are both functions of time but are based on the known exemplar state information. Therefore, A(t) and Q^{T}(t) may be generated before the verb is executed by the robot or may be generated during verb execution but prior to time t.

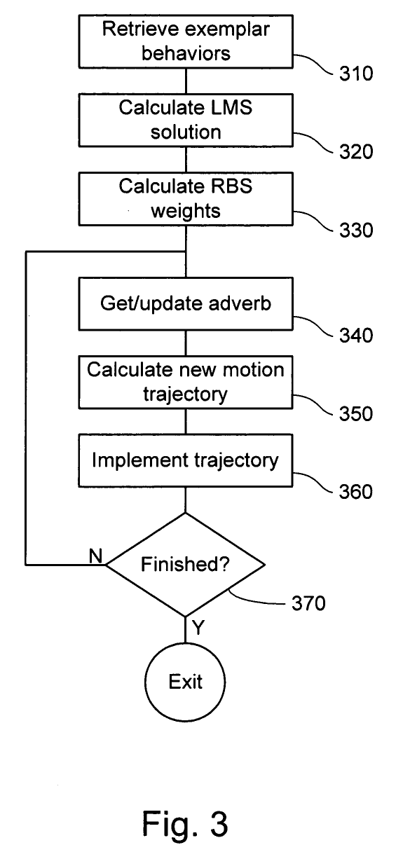

FIG. 3 is a flow diagram illustrating an embodiment of the present invention. In FIG. 3, a set of behaviors and their associated targets are retrieved from storage memory based on the desired task in step 310. In a preferred embodiment, the behaviors are created via teleoperation. The LMS solution and RBF weights are generated in steps 320 and 330, respectively, based on the retrieved behaviors and their associated targets. The order of steps 320 and 330 is not critical and may be done in reverse order. In step 340, a target associated with the desired task is retrieved or updated and r(p) is calculated. In step 350, the sensory motor state vector is calculated based on A(t), Q^{T}(t), and the adverb. In step 360, the calculated trajectory is implemented by controlling the actuators and motors of the robot to match their respective values in the calculated state vector. A determination is made on whether the desired task has been completed in step 370. If the task is has not finished, the process jumps to step 340 to repeat the loop 340-350-360-370 until the task is finished.

In the embodiment illustrated in FIG. 3, the robot performs the task as the state vector is calculated. This has the advantage of enabling the robot to “track” a moving target adverb and/or more precisely locate the target as the task is being performed. In other embodiments, the entire task may be calculated before commencing the task when the task has a static target.

Having thus described at least illustrative embodiments of the invention, various modifications and improvements will readily occur to those skilled in the art and are intended to be within the scope of the invention. Accordingly, the foregoing description is by way of example only and is not intended as limiting. The invention is limited only as defined in the following claims and the equivalents thereto.

What is claimed:

1. A method for determining a trajectory for a robot, the method comprising:
providing at least one behavior, each of the at least one behavior having an associated target;
approximating the trajectory based on the at least one behavior and the associated target; and
correcting the trajectory based on a new target associated with the trajectory.

2. The method of claim 1 wherein the approximating step is a least-mean-square solution.

3. The method of claim 1 wherein the correcting step is a radial basis function correction.

4. The method of claim 3 wherein a radial basis function is multiplied by one or more weights, the one or more weights calculated to generate a trajectory that matches the at least one behavior when the associated target is selected as the new target.
